(19) United States
(12) Patent Application Publication
(10) Pub. No.: US 2015/0144113 A1
(43) Pub. Date: May 28, 2015

(54) METHOD AND DEVICE FOR OPERATING AN INTERNAL COMBUSTION ENGINE

(71) Applicant: Robert Bosch GmbH, Stuttgart (DE)

(72) Inventors: Sven MERKLE, Stuttgart (DE); Michael DRUNG, Muehlacker (DE); Matthias PFAU, Meiningen (DE); Rainer MAIER, Stuttgart (DE); Martin KROENER, Remchingen (DE); Matthias SIMONS, Stuttgart (DE); Andreas BETHMANN, Rutesheim (DE)

(21) Appl. No.: 14/554,118

(22) Filed: Nov. 26, 2014

(30) Foreign Application Priority Data
Nov. 28, 2013 (DE) 10 2013 113 167.0

(51) Int. Cl. F02D 13/02; F01L 1/344; F02D 33/02; F02D 23/00; F01L 1/34; F02D 9/08

(52) U.S. Cl. CPC F02D 13/0238; F01L 1/34; F02D 9/08; F02D 33/02; F02D 23/00; F01L 1/344; F01L 2800/00
USPC 123/561; 123/90.1; 123/90.17; 123/90.15; 701/103

(57) ABSTRACT

A method for operating an internal combustion engine is described, the internal combustion engine including a cylinder having an inlet valve for supplying fresh air from an intake manifold in a controlled manner, an air filling being set in a certain operating mode by predefining a closing point in time of the inlet valve in an intake stroke at a constant intake manifold pressure.

### FIELD OF THE INVENTION

The present invention relates, in general, to the field of internal combustion engines and, in particular, to methods for controlling the filling of the cylinders of an internal combustion engine.

### BACKGROUND INFORMATION

Nowadays, conventional gasoline engines are operated in intake manifold operation, i.e., in a low load and torque range, in such a way that the air filling in the cylinders is set via a position of the throttle valve. In higher load and torque ranges, the intake manifold operation is replaced by the charging operation in that the air filling is predominantly determined through the variable compression output of a supercharging device, such as a turbocharger.

In intake manifold operation, it is assumed that the mass flow through the throttle valve corresponds to the fresh air mass flowing into the cylinder after the buildup of the intake manifold pressure.

In the conventional intake manifold operation in a gasoline engine, charge cycle losses occur, which reduce the efficiency of the internal combustion engine, in the event of a valve clearance during which an inlet valve closes at a bottom dead center of a piston movement. Furthermore, modern internal combustion engines allow for a variable adjustment of the closing point in time of the inlet valves in the crankshaft angle range. Modern systems also allow for a closing point in time to be provided in the range of the maximum piston speed (fully variable valve-gear assembly), i.e., at crankshaft angles of +/−90° with respect to the bottom dead center. In operating modes having closing points in time of inlet valves in crankshaft angle ranges which are removed from the bottom dead center, the intake manifold pressure is no longer the only variable which has a dominant effect on the air filling in the cylinders. In addition, the filling control through adjustment of the throttle valve is no longer reliable for internal combustion engines of this type, since in the event of changed surrounding conditions, it cannot be guaranteed, for example, that the setpoint filling is reached using the desirable camshaft position.

### SUMMARY

According to the present invention, the method for operating an internal combustion engine is provided, and the device, the engine system, and the computer program are provided.

According to one first aspect, a method is provided for operating an internal combustion engine, the internal combustion engine including a cylinder having an inlet valve for supplying fresh air from an intake manifold in a controlled manner, an air filling being set in a certain operating mode by predefining a closing point in time of the inlet valve in an intake stroke at a constant or constantly controlled intake manifold pressure.

One idea of the method described above is to set the control of the air filling in the cylinders via a phase position of the inlet camshaft, in particular via an adjustment of the closing point in time of the inlet valve, in the intake manifold operation of an internal combustion engine. For this purpose, closing points in time are suitable, in particular, which are close to the range of the maximum piston speed, since this is where the influence of the closing point in time considerably outweighs the influence of the intake manifold pressure. In particular, the control of the air filling in the cylinders is based on the adjustment of a closing point in time of the inlet valve at a constant intake manifold pressure which is, in particular, optimized for reducing the effort for charge cycles. In this way, different strategies may be provided which set the air filling in different operating ranges of the internal combustion engine through a variation of a closing point in time of the inlet valve, a setting of the throttle valve, and a setting of an efficiency of a supercharging device, e.g., by actuating a waste gate valve.

It is thus possible, even under changed surrounding conditions such as low ambient pressure in higher geographic locations, to ensure that the setpoint filling is reached using the desirable camshaft position.

Furthermore, the certain operating mode may be determined through a range of air fillings to be set in the cylinder.

It may be provided that the closing point in time of the inlet valve is set in the cylinder in the certain operating mode to a range between 70° KW and 180° KW after the top dead center of a piston movement.

According to one specific embodiment, the constant intake manifold pressure in the certain operating mode may be set by controlling a position of the throttle valve.

The closing point in time of the inlet valve may be set with the aid of a camshaft phase adjuster.

It may be provided that the internal combustion engine is operated in an intake manifold operating mode when the air filling to be set is below a first predefined air filling threshold value, the air filling being set in the intake manifold operating mode by controlling the throttle valve and the closing point in time of the inlet valve being optimized according to smooth running as well as to fuel consumption of the internal combustion engine, and the certain operating mode being assumed when the air filling to be set is above the first air filling threshold value.

It may furthermore be provided that the internal combustion engine is operated in a charging operating mode when the air filling to be set is above a second predefined air filling threshold value, the air filling being set in the charging operating mode by controlling the efficiency of a supercharging device which provides fresh air under an increased pressure, and the closing point in time of the inlet valve being set to a predefined maximum value, and the certain determined operating mode being assumed when the air filling to be set is below the second air filling threshold value.

According to another aspect, a device is provided, in particular a control unit, for operating an internal combustion engine which includes a cylinder having an inlet valve for supplying fresh air from an intake manifold in a controlled manner, the device being designed to set an air filling in a certain operating mode by predefining a closing point in time of the inlet valve in an intake stroke at a constant intake manifold pressure.

According to another aspect, an engine system is provided which includes an internal combustion engine and the device described above.

Furthermore, a camshaft phase adjuster may be provided to variably set a closing point in time of the inlet valve.

According to another aspect, a computer program is provided which is designed to carry out all steps of the method described above.

### BRIEF DESCRIPTION OF THE DRAWINGS

FIG. 1 shows a schematic representation of an engine system which includes an internal combustion engine;

FIG. 2 shows a representation of the chargeable cylinder volume at different closing points in time of the inlet valve with reference to the crankshaft angle;

FIG. 3 shows a representation of the filling increase as a result of a camshaft adjustment at constant intake manifold pressure; and

FIG. 4 shows a representation of different operating modes for filling control.

### DETAILED DESCRIPTION

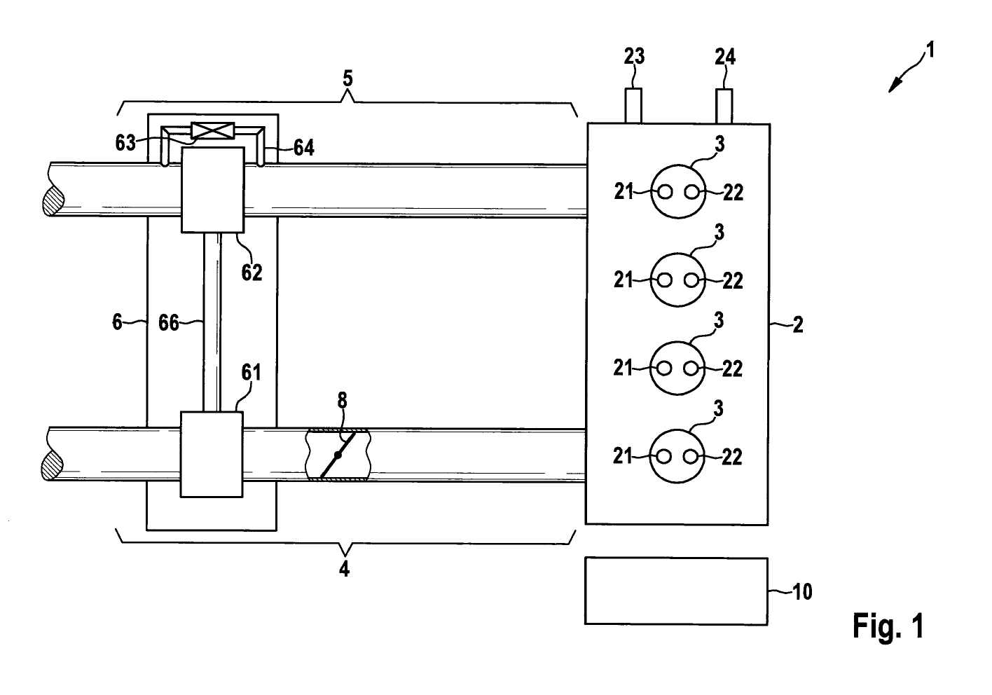

FIG. 1 shows an engine system 1 which includes an internal combustion engine 2 and which may be designed, for example, as a gasoline engine. Internal combustion engine 2 includes cylinders 3 having a combustion chamber in which a movable piston is situated (not shown), so that four-stroke operation is possible including the combustion cycles combustion stroke, emission stroke, intake stroke, and compression stroke.

Fresh air is suppliable to cylinders 3 via an air supply system 4. During operation of internal combustion engine 2, a fuel-air mixture is combusted in the combustion chambers, and the resulting combustion exhaust gas is ejected into an exhaust gas discharge section 5 and finally discharged into the surroundings.

Engine system 1 furthermore includes an exhaust gas-driven supercharging device 6, which includes a compressor 61 and which is situated in an air supply system 4. Compressor 61 is designed to draw in fresh air from the surroundings of engine system 1 and to supply it to internal combustion engine 2 under an increased pressure, the so-called charging pressure. Compressor 61 is mechanically coupled via a shaft 66 to a turbine 62, which is situated in exhaust gas discharge section 5. Turbine 62 is used to convert exhaust gas enthalpy from the exhaust gas flow ejected from internal combustion engine 2 into mechanical energy for the purpose of accordingly driving compressor 61. Turbine 62 is bypassed via a bypass line 64 in which a waste gate valve 63 is situated. Waste gate valve 63 is variably activatable and is used to set the efficiency of supercharging device 6 in order to control in this way the compression output to be made available. Other possibilities of variably setting the efficiency of supercharging device 6 are also conceivable.

A throttle valve 8, which may be used to set the amount of fresh air to be supplied to internal combustion engine 2, is furthermore situated in the section of air supply system 4 between compressor 61 and cylinders 3 of internal combustion engine 2. The section of air supply system 4 between throttle valve 8 and inlet valves 21 is referred to as an intake manifold.

The fresh air is let in with the aid of inlet valves 21 into cylinders 3 in a controlled manner and ejected accordingly via exhaust valves 22 in exhaust gas discharge section 5. The valve-gear assemblies are set by an inlet valve camshaft actuator 23 and an exhaust valve camshaft actuator 24 which are coupled to an output shaft of internal combustion engine 2. In the present case, camshaft actuators 23, 24 are designed in such a way that a fully variable valve-gear assembly is possible at least for inlet valves 21. This means that the opening and closing points in time of inlet valves 21 are settable within a wide range with regard to an ignition point in time or crankshaft angle, and a closing point in time of inlet valves 21 may thus also be in a range of a maximum piston movement of a cylinder 3.

A control unit 10 is furthermore provided which suitably operates engine system 1 for providing a certain engine torque. In gasoline engines, this set engine torque results from the air filling present in cylinders 3. The fuel quantity to be injected is then metered as a function of the air filling present in cylinders 3.

In order to control engine system 1, control unit 10 detects operating states of internal combustion engine 2, for example the engine speed, the amount of fresh air supplied, and the like, engine system 1 being suitably operated by taking into account a predefined setpoint variable, for example a setpoint engine torque, by setting actuators, such as throttle valve 8, an actuator for setting the efficiency of supercharging device 6, fuel injectors on cylinders 3 as well as inlet valve and exhaust valve actuators 23, 24.

In principle, internal combustion engines may be operated at different operating points in different ways. At a high load, a large amount of exhaust gas enthalpy is provided and used for conversion into mechanical energy. In this way, a corresponding compression output is provided. This compression output results in a high charging pressure on the output side of compressor 61 in the case of a high supplied air mass flow rate, so that a charging operating mode of internal combustion engine 2 may be set. At a low load, e.g., when idling, only a small amount of exhaust gas enthalpy is available, so that the available compression output is small and internal combustion engine 2 is operated in an intake manifold operating mode as long as the base turbocharging range prevails during which compressor 61 essentially cannot make charging pressure available.

If the control of the closing point in time of inlet valve 21 through inlet valve camshaft actuator 23 is essentially fully variable, a closing point in time may also be set at a crankshaft angle of 90° before a bottom dead center, i.e., between a top and a bottom dead center of the piston movement during the intake stroke. In this crankshaft angle range, the piston in cylinder 3 in question has the maximum piston speed, so that the pressure in the intake manifold is no longer the variable which has a dominant effect on the amount of the air filling in cylinder 3. Therefore, the filling control through influencing the intake manifold pressure, such as the one known from the intake manifold operation according to the related art, no longer yields the desirable results, since in the case of changed surrounding conditions, such as a changed ambient pressure, for example, it is not guaranteed that the setpoint filling is reached using the desirable camshaft position.

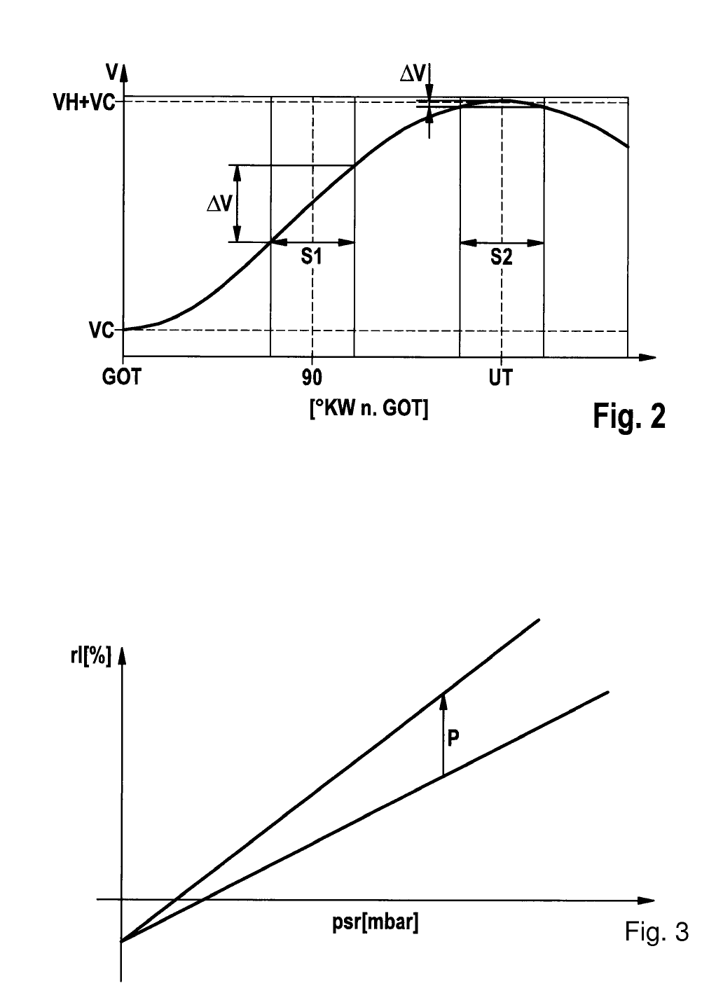

The strong influence of the closing point in time of inlet valves 21 is illustrated in FIG. 2, which shows a diagram of the profile of volume V of cylinders 3 against crankshaft angle KW after top dead center GOT. FIG. 2 thus illustrates how the air filling behaves as a function of a closing point in time of inlet valve 21 in question and as a function of instantaneous cylinder volume V. It is apparent that in the case of a closing point in time for inlet valve 21 at a crankshaft angle of approximately 90° (section S1) between the top and bottom dead center UT, a change (sensitivity dV/dKW) in the closing point in time brings about a great change of cylinder volume V to be filled with fresh air in comparison to a change in the closing point in time at a crankshaft angle KW which is close to bottom dead center UT (section S2).

It is therefore provided that in an intake manifold operating mode in which merely a base charging pressure, which is in general only slightly above the ambient pressure, e.g., between 1.1 and 1.3 times of the ambient pressure, is provided by supercharging device 6 before throttle valve 8, and that the air filling in cylinders 3 is determined by adjusting the closing point in time of inlet valve 21 of cylinder 3 to be filled about the range of the maximum piston movement, i.e., 90° after the top dead center. This preferably takes place at an intake manifold pressure which is kept constant.

The intake manifold pressure is preferably selected in such a way that the charge cycle losses are preferably minimized. In particular, the intake manifold pressure may be controlled by control unit 10 to a predefined value between 0.8 times of the ambient pressure and the ambient pressure. In order to keep the intake manifold pressure constant, a pressure control may be implemented which acts on the position of throttle valve 8 in order to keep the intake manifold pressure constant.

FIG. 3 schematically shows a diagram which indicates relative air filling rl against an intake manifold pressure psr. Arrow P indicates how the air filling may be adjusted at a constant intake manifold pressure by predefining the closing point in time of inlet valve 21.

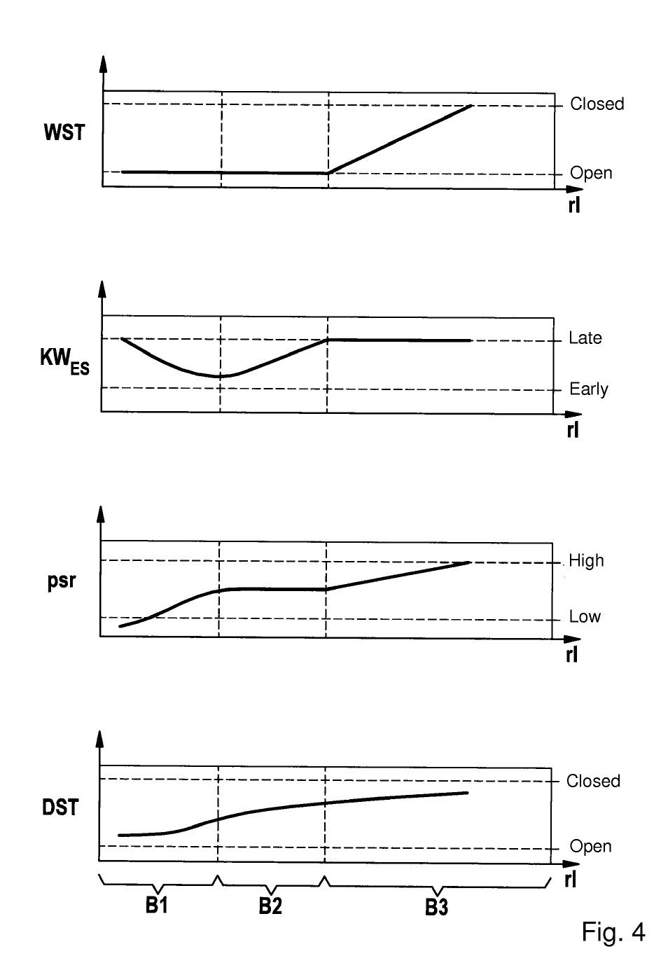

In particular, the selected setpoint intake manifold pressure, to which the intake manifold pressure is controlled, is a function of the desirable filling control strategy or an operating mode of the internal combustion engine. Depending on the requested air filling or the setpoint torque which is a function thereof, one of operating modes B1, B2, or B3 may be selected, as illustrated in FIG. 4. The diagrams show profiles of a position WST of waste gate valve 63 (higher values correspond to a further closed position of the waste gate valve), a crankshaft angle KW_{ES} at the closing point in time of the inlet valve, intake manifold pressure psr as well as position DST of throttle valve 8 (higher values correspond to a further opened position of the waste gate valve).

According to a first operating mode B1 (intake manifold operating mode), it is provided that waste gate valve 63 of supercharging device 6 is opened in such a way that only a minimum charging pressure, the base charging pressure, is made available. This operating mode B1 is assumed in a low load range. The filling control takes place by actuating throttle valve 8. The closing points in time of inlet valves 21 are optimized with respect to smooth running and fuel consumption.

In a second operating mode B2, the load range of which follows the load range of first operating mode B1, it may be provided that a charging still does not take place by supercharging device 6, i.e., waste gate valve 63 remains open. However, an intake manifold pressure control is activated which controls the intake manifold pressure to a constant intake manifold pressure value. The intake manifold pressure value is predefined in such a way that the charge cycle losses in cylinders 3 are preferably minimized The intake manifold pressure value is a function of the design of internal combustion engine 2. In order to keep the intake manifold pressure constant, a corresponding adaptation of the position of throttle valve 8 is necessary due to the larger air quantity as the load of internal combustion engine 2 increases, which is apparent from the corresponding characteristic curve of FIG. 4.

In second operating mode B2 (camshaft operating mode), the air filling in cylinders 3 which is necessary for providing the setpoint engine torque is furthermore set by predefining the closing point in time of inlet valves 21. As the necessary air filling increases, the closing point in time is shifted toward late until a certain maximum value, which is predefined by the mechanical components or an input, for the closing point in time is reached. This maximum value is in a crankshaft angle range of +/−20° about the bottom dead center.

If the maximum value for the closing point in time is reached, i.e., the filling control does not enable another increase in the air filling in cylinders 3 through the manipulation of the closing point in time of inlet valve 21, a third operating mode B3 (charging operating mode) is transitioned into if the load of internal combustion engine 2 continues to increase. In third operating mode B3, the air filling is controlled by establishing the charging pressure. For this purpose, it is necessary to delimit the setpoint value, which is output to a charging pressure control/regulation, to the charging pressure which is necessary in the striking position of inlet valve camshaft actuator 23.

Furthermore, it may be possible according to another operating mode to keep waste gate valve 63 only partially closed, while the air filling in cylinders 3 is taking place with the aid of a manipulation of the closing point in time of inlet valve 21.

What is claimed is:

1. A method for operating an internal combustion engine, wherein the internal combustion engine includes a cylinder having an inlet valve for supplying fresh air from an intake manifold in a controlled manner, the method comprising:
setting a desired air filling in a certain operating mode by predefining a closing point in time of an inlet valve in an intake stroke at a constant intake manifold pressure.

2. The method as recited in claim 1, wherein the certain operating mode is determined through a range of air fillings to be set in the cylinder.

3. The method as recited in claim 1, wherein the closing point in time of the inlet valve is set in the cylinder in the certain operating mode to a range between 70° KW and 180° KW after a top dead center of a piston movement.

4. The method as recited in claim 1, wherein the constant intake manifold pressure in the certain operating mode is set by controlling a position of a throttle valve.

5. The method as recited in claim 1, wherein the closing point in time of the inlet valve is set with the aid of a camshaft phase adjuster.

6. The method as recited in claim 1, wherein the internal combustion engine is operated in an intake manifold operating mode when the air filling to be set is below a first predefined air filling threshold value, the air filling being set in the intake manifold operating mode by controlling a throttle valve, and the closing point in time of the inlet valve being optimized according to at least one of a smooth running and fuel consumption of the internal combustion engine, and the certain operating mode being assumed when the air filling to be set is above the first predefined air filling threshold value.

7. The method as recited in claim 6, wherein the internal combustion engine is operated in a charging operating mode when the air filling to be set is above a second predefined air filling threshold value, the air filling being set in the charging operating mode by controlling an efficiency of a supercharging device which provides fresh air under an increased pressure, and the closing point in time of the inlet valve being set to a predefined maximum value, and the certain operating mode being assumed when the air filling to be set is below the second predefined air filling threshold value.

8. A device for operating an internal combustion engine which includes a cylinder having an inlet valve for supplying fresh air from an intake manifold in a controlled manner, the device comprising:
an arrangement for setting a desired air filling in a certain operating mode by predefining a closing point in time of an inlet valve in an intake stroke at a constant intake manifold pressure.

9. The device as recited in claim 8, wherein the device is a control unit.

10. An engine system, comprising:
an internal combustion engine that includes a cylinder having an inlet valve for supplying fresh air from an intake manifold in a controlled manner; and
a device for operating the internal combustion engine , the device comprising:
an arrangement for setting a desired air filling in a certain operating mode by predefining a closing point in time of an inlet valve in an intake stroke at a constant intake manifold pressure.

11. The engine system as recited in claim 10, further comprising a camshaft phase adjuster to variably set the closing point in time of the inlet valve.

12. A computer program which is configured to carry out on a computing device a method for operating an internal combustion engine, wherein the internal combustion engine includes a cylinder having an inlet valve for supplying fresh air from an intake manifold in a controlled manner, the method comprising:
setting a desired air filling in a certain operating mode by predefining a closing point in time of an inlet valve in an intake stroke at a constant intake manifold pressure.

13. An electronic storage medium on which a computer program is stored, the computer program being configured to carry out on a computing device a method for operating an internal combustion engine, wherein the internal combustion engine includes a cylinder having an inlet valve for supplying fresh air from an intake manifold in a controlled manner, the method comprising:
setting a desired air filling in a certain operating mode by predefining a closing point in time of an inlet valve in an intake stroke at a constant intake manifold pressure.

14. An electronic control unit, comprising:
an electronic storage medium on which a computer program is stored, the computer program being configured to carry out on a computing device a method for operating an internal combustion engine, wherein the internal combustion engine includes a cylinder having an inlet valve for supplying fresh air from an intake manifold in a controlled manner, the method comprising:
setting a desired air filling in a certain operating mode by predefining a closing point in time of an inlet valve in an intake stroke at a constant intake manifold pressure.
